(19) United States
(12) Patent Application Publication
(10) Pub. No.: US 2025/0094103 A1
(43) Pub. Date: Mar. 20, 2025

(54) SYSTEM AND METHOD FOR DYNAMIC TRANSLATION OF PRINTER SPECIFIC PJL COMMANDS

(71) Applicant: Toshiba TEC Kabushiki Kaisha, Shinagawa-ku (JP)

(72) Inventors: William Su, Riverside, CA (US); Chris Nguyen, Huntington Beach, CA (US)

(21) Appl. No.: 18/369,544

(22) Filed: Sep. 18, 2023

(51) Int. Cl. G06F 3/12

(52) U.S. Cl. CPC G06F 3/1247; G06F 3/1206

(57) ABSTRACT

A system and method is provided for rendering print jobs emanating from a manufacturer specific printer driver on a printer from a different manufacturer. Non-compatible Printer Job Language (PJL) codes are detected and a lookup table is consulted to determine one or more compatible codes that accomplish the functionality of an incompatible code. These compatible codes injected into the print job PJL as substitute code, allowing the job to be rendered correctly.

### TECHNICAL FIELD OF THE INVENTION

This application relates generally to printing. The application relates more particularly to automated translation of Printer Job Language commands issued by a print driver during a print operation based on a printer selected for printing.

### BACKGROUND OF THE INVENTION

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

When documents are printed from a computer, a print driver acts as an intermediary between a software application, such as Microsoft Word, and the printer. The print driver converts document data into a format that the printer can understand. Part of this conversion process involves sending control commands to the printer to set various parameters and options for a print job. These control commands often include Printer Job Language (PJL) commands. The print driver generates PJL commands to communicate with the printer and specify print settings for the job. PJL is a language utilized by MFPs, laser printers and certain inkjet printers to manage various aspects of printing jobs. PJL commands are typically employed to transmit instructions and settings to the printer before or during a print job. These commands can be incorporated within a print job or dispatched independently.

Common tasks and settings that can be managed through PJL commands include configuring the printer, adjusting job parameters, monitoring job status, and assessing printer-related information. PJL commands are instrumental in defining page formatting, selecting paper trays, specifying fonts, and introducing separators or coversheets within print jobs.

PJL often operates in conjunction with other printer control languages, such as PCL (Printer Control Language) and PostScript, to offer precise control over the printing process. It is particularly beneficial in scenarios where meticulous management of printer settings is essential, such as in networked office environments or when printing from specialized software applications.

To employ PJL commands, devices transmit them to the printer as part of the print job or via a separate communication channel, such as a terminal or print management system. The specific PJL commands and their syntax can vary depending on the printer model and manufacturer.

### BRIEF DESCRIPTION OF THE DRAWINGS

Various embodiments will become better understood with regard to the following description, appended claims and accompanying drawings wherein:

FIG. 1 is an example embodiment of a system for dynamic translation of printer specific PJL commands;

FIG. 2 is an example embodiment of a networked digital device, such as a multifunction peripheral;

FIG. 3 is an example embodiment of a digital device system;

FIG. 4 is a system overview of an example embodiment of a system for dynamic translation of printer specific PJL commands;

FIG. 5 is an example embodiment of a software block diagram of a system for dynamic translation of printer specific PJL commands; and

FIG. 6 is s flowchart of an example embodiment of a system for dynamic translation of printer specific PJL commands.

### DETAILED DESCRIPTION OF THE INVENTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

As noted above, PJL commands can vary with commands created specifically for a particular device type or manufacturer. Certain PJL commands may be shared in common. A standard set of PJL commands that has been defined by the Printer Working Group (PWG), and is widely supported across various printer brands and models. The Printer Working Group (PWG) is a collaborative consortium of printer and MFP manufacturers and other interested parties. Its primary goal is to develop and promote industry standards and specifications related to printing and imaging technologies. The PWG operates under the auspices of the IEEE Industry Standards and Technology Organization (ISTO), which provides a framework for developing and publishing open standards.

Standardized commands encompass fundamental printer functions, serving as a universal framework for interacting with printers. Included in this set are commands like ‘@PJL JOB’ to initiate a new print job, ‘@PJL SET’ for configuring printer parameters such as paper size and duplex printing, and ‘@PJL INFO’ for retrieving vital information about a printer's configuration and capabilities. ‘@PJL RESET’ allows for the cancellation of a print job, while ‘@PJL COMMENT’ enables the inclusion of comments or remarks within a print job. ‘@PJL ENTER LANGUAGE’ facilitates the switch to specific printer languages like PCL or PostScript, and ‘@PJL EOJ’ marks the conclusion of a print job. Moreover, ‘@PJL USTATUS DEVICE’ provides real-time updates on the printer's status. Printers may support some or all of the standard PJL commands, and some printers may offer custom or proprietary PJL codes.

Custom PJL codes are utilized by printer manufacturers to extend the functionality of their printers, providing specialized features and control options beyond the standard PJL commands. These codes enable features such as advanced paper handling, toner or ink management, secure printing, job accounting, and tracking, as well as custom print modes, barcode printing, and the ability to add watermarks, overlays, or custom fonts to printed documents. They are also used for printer maintenance, access control, error messaging, language translation, specialty label printing, and configuring settings for handling specialty print media. Custom PJL codes enhance the versatility of printers, allowing users to tailor their printing experience to specific requirements or industry needs.

If a print driver from one manufacturer is used to send a print job to a device from another manufacturer, a job may still print, but in an undesired form or format. For example, printing color documents in black and white using the Toshiba TEC's Universal Print Driver is correct on Toshiba devices, but when printing on Lexmark, the output is in color. It may be undesirable, impractical or unfeasible for one manufacturer to add third party manufacturer specific PJL commands to their print driver. Adding custom PJL codes from multiple manufacturers would be impractical and time consuming, as well as create possible conflicts.

Example embodiments herein provide a mechanism that allows jobs to be printed correctly on different printers, regardless of which print driver is used. After a user prints a document, an MFP gets the print job and reads PJL commands from the print job. The MFP then detects the incompatible PJL and then injects with the compatible version from a mapping table. This provides an ability to modify print job at the MFP level and an ability to detect the incompatible PJL and then inject with the compatible version. Thus documents print correctly on different printers regardless of which print driver is used.

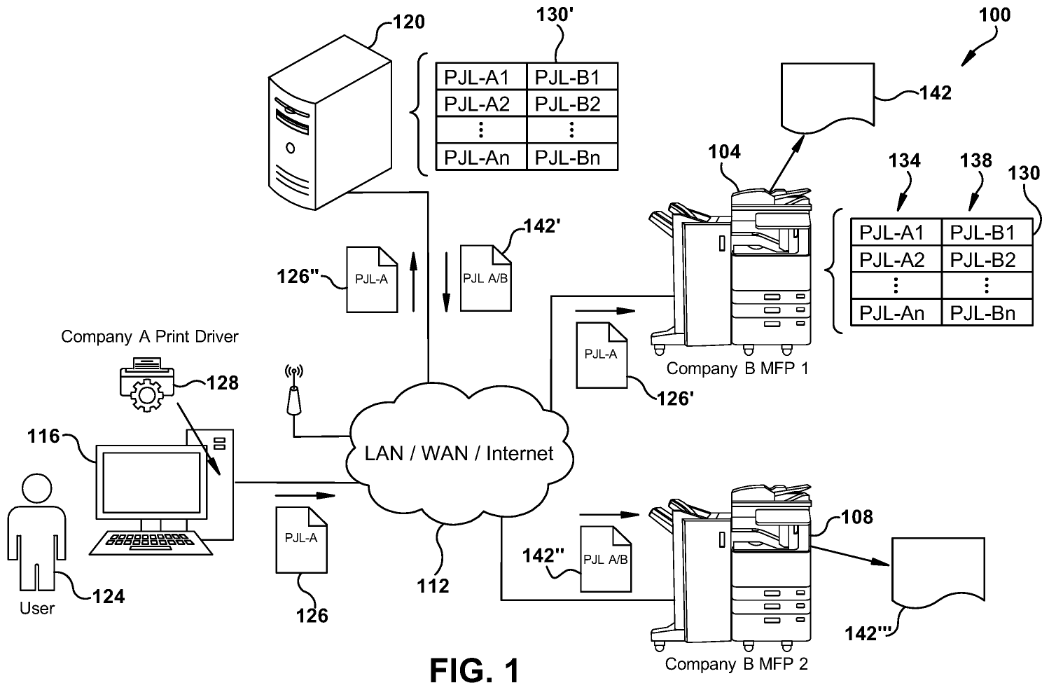

FIG. 1 illustrates an example embodiment of a system 100 for dynamic translation of printer specific PJL commands. One or more MFPs, such as MFP 104 and MFP 108 are in data communication with network cloud 112. Network cloud 112 is suitably comprised of a local area network (LAN), a wide area network (WAN), which may comprise the Internet, or any suitable combination thereof. Network cloud 112 is comprised of any suitable wireless or wired data connection or combination thereof and provides for data transfer between devices, such as MFPs 104 and 108, workstation 116 and server 120.

In the illustrated example, user 124 operates workstation 116 and sends a print job 126 to one or more MFPs via installed print driver 128. Print driver 128 is issued by Company A specifically for use with Company A MFPs. However, MFPs 104 and 108 are made by Company B. Print job 126 includes Company A specific PJL codes that will not be recognized by MFPs 104 and 108.

In a first example, print job 126 with Company A PJL is sent via network cloud 112 as print job 126′ to Company B MFP 104 which is provided with lookup table 130. Lookup table 130 includes PJL entries 134 corresponding to Company A specific PJL commands. Each PJL entry 134 is associated with a corresponding PJL entry 138 of Company B PJL commands. It is to be understood that there is not necessarily a one-to-one mapping between associated PJL codes. For example, multiple PJL commands in Company A PJL may be replaced by a single Company B PJL command. Similarly, a single Company A PJL command may be replaced by two or more Company B PJL commands and the modified PJL is used to generate printout 142 correctly. Additionally, lookup tables may include substitute PJL for MFPs from two or more companies.

In a second example, print job 126 is sent via network cloud 112 as print job 126″ to server 120 which is provided with lookup table 130′. Incompatible PJL codes are detected and replaced by server 120 to generate print job 142′ with replacement codes. When the print job 142′ reaches MFP 108 via network cloud 112 as print job 142″, it generates printout 142′″ correctly. Use of a print server for PJL translation may be advantageous insofar as

When print job 126 is sent directly to MFP 104 via network cloud 112, the MFP analyzes the incoming PJL code and determines which code or codes are incompatible. Lookup table 130 is used to find substitute PJL codes which replace detected incompatible codes. Thus, it would not be necessary to install and maintain lookup tables on each potentially incompatible MFP.

A particular PJL code replacement addresses the issue noted above wherein a Toshiba print driver sends a color document to a Lexmark printer for black and white printing. Left alone the PJL will cause a color printout notwithstanding a Toshiba driver setting for black and white. To address this issue, a suitable PJL substitution implementation can be described as the following steps:

| | |
|---|---|
| 1. | Get the print job. |
| 2. | Read the Toshiba PJL commands from the print job. |
| 3. | Change the following PJL command: |
| | From: @PJL COMMENT DSSC PRINT |
| | RENDERMODE=GRAYSCALE (Toshiba PJL) |

| | |
|---|---|
| To: | @PJL COMMENT DSSC PRINT |
| | RENDERMODE=GRAYSCALE @PJL SET |
| | LCOLORMODEL=BLACK (Lexmark PJL) |

Another example is the compatibility issue with printing documents in duplex. To solve this problem, the implementation can be described as the following steps;

| 1. | Printer gets the print job. | |
|---|---|---|
| 2. | Printer reads the Toshiba PJL commands from the print job. | |
| 3. | Printer changes the following PJL commands: | |
| | a. | Simplex |

From: @PJL COMMENT DSSC PRINT DUPLEX=0 (Toshiba PJL)

| | |
|---|---|
| To: | @PJL SET DUPLEX=OFF (Lexmark PJL) |
| | @PJL COMMENT DSSC PRINT DUPLEX=0 |

| | |
|---|---|
| b. | Duplex Long Edge |

From: @PJL COMMENT DSSC PRINT DUPLEX=1 (Toshiba PJL)

| | |
|---|---|
| To: | @PJL SET DUPLEX=ON (Lexmark PJL) |

| | |
|---|---|
| | @PJL SET BINDING=LONGEDGE (Lexmark PJL) |
| | @PJL COMMENT DSSC PRINT DUPLEX=1 |
| c. | Duplex Short Edge |

From: @PJL COMMENT DSSC PRINT DUPLEX=1 (Toshiba PJL)

| | |
|---|---|
| To: | @PJL SET DUPLEX=ON (Lexmark PJL) |

@PJL SET BINDING=LONGEDGE (Lexmark PJL)
@PJL COMMENT DSSC PRINT DUPLEX=1

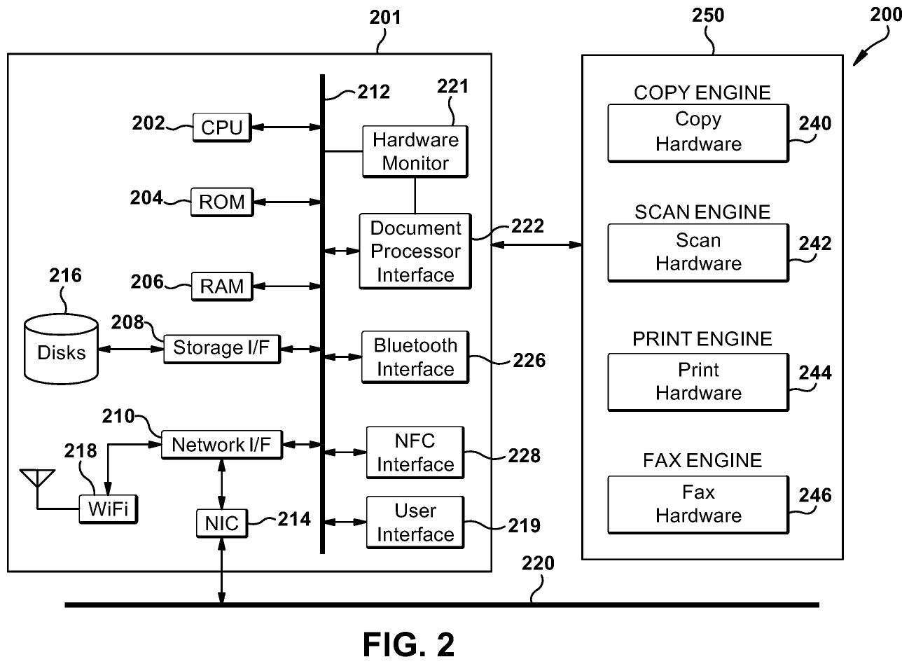

Turning now to FIG. 2, illustrated is an example embodiment of a networked digital device comprised of document rendering system 200 suitably comprised within an MFP, such as with MFPs 104 and of FIG. 1. It will be appreciated that an MFP includes an intelligent controller 201 which is itself a computer system. Thus, an MFP can itself function as a server with the capabilities described herein. Included in intelligent controller 201 are one or more processors, such as that illustrated by processor (CPU) 202. Each processor is suitably associated with non-volatile memory, such as read-only memory (ROM) 204, and random access memory (RAM) 206, via a data bus 212.

Processor 202 is also in data communication with input/output interface 219, suitably comprising a user touchscreen. While touchscreens are discussed in example embodiments herein, it is to be appreciated that any suitable user interface, such as keyboards, switches, displays, trackballs or mice may be used.

Processor 202 is also in data communication with a storage interface 208 for reading or writing to a storage 216, suitably comprised of a hard disk, optical disk, solid-state disk, cloud-based storage, or any other suitable data storage as will be appreciated by one of ordinary skill in the art.

Processor 202 is also in data communication with additional interfaces, such as Bluetooth interface 226 and NFC interface 228.

Processor 202 is also in data communication with a network interface 210 which provides an interface to a network interface controller (NIC) 214, which in turn provides a data path to any suitable wired interface or physical network connection 220, or to a wireless data connection via wireless network interface 218. Example wireless network interfaces include optical, cellular, Wi-Fi, wireless universal serial bus (wireless USB), satellite, and the like. Example wired interfaces include Ethernet, USB, IEEE 1394 (FireWire), Lightning, telephone line, or the like.

Processor 202 can also be in data communication with any suitable user input/output (I/O) network interface 219 which provides data communication for interfacing with user peripherals, such as displays, keyboards, mice, track balls, touch screens, or the like. Processor 202 can also be in communication with hardware monitor 221, such as a page counter, temperature sensor, toner or ink level sensor, paper level sensor, or the like.

Also in data communication with data bus 212 is a document processor interface 222 suitable for data communication with the document rendering system 250, including MFP functional units. In the illustrated example, these units include a copy engine comprising copy hardware 240, a scan engine comprise of scan hardware 242, a print engine comprised of print hardware 244 and a fax engine comprised of fax hardware 246 which together comprise document rendering system 250. It will be understood that functional units are suitably comprised of intelligent units, including any suitable hardware or software platform.

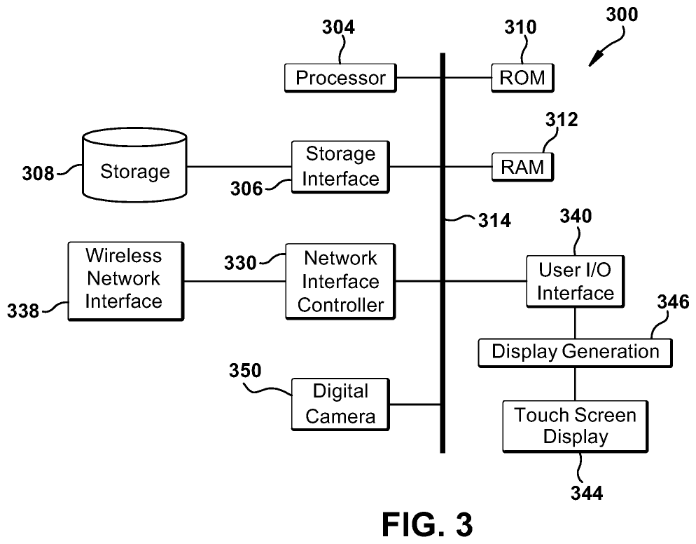

Turning now to FIG. 3, illustrated is an example embodiment of a digital data processing device 300 such as workstation 116 and server 120 of FIG. 1. It is to be appreciated that some components listed may be unnecessary in certain configurations. Components of the digital data processing device 300 suitably include one or more processors, illustrated by processor 304, memory, suitably comprised of read-only memory 310 and random access memory 312, and bulk or other non-volatile storage 308, suitably connected via a storage interface 306. Data communication among components is accomplished via data bus 314. A network interface controller 330 suitably provides a gateway for data communication with other devices, via any wireless or wired connection, such as via wireless network interface 338. A user input/output interface 340 is suitably comprised of display generator 346 interfacing with touchscreen display 344. As noted above, any suitable user input and display can be used.

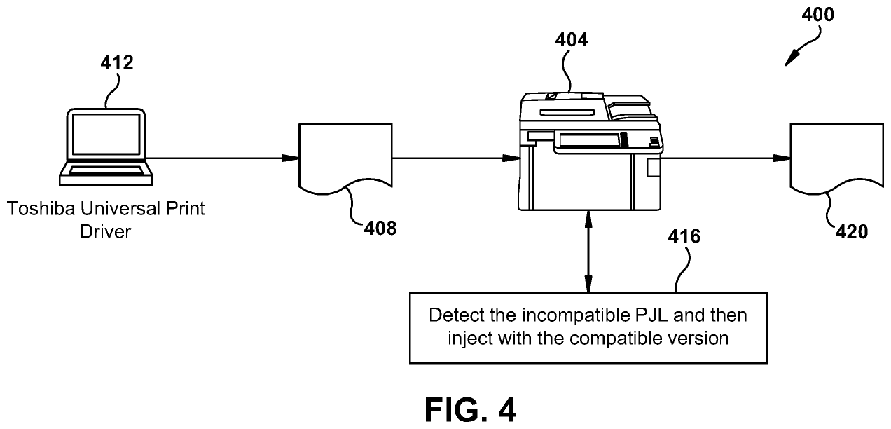

FIG. 4 illustrates a system overview 400 of an example embodiment of a system for dynamic translation of printer specific PJL commands. Lexmark printer 404 receives print job 408 from a Toshiba Universal Print driver in workstation 412. Printer 404 detects incompatible PJL and then injects substitute, compatible PJL at block 416. The resulting printout 420 is rendered correctly as specified by the Toshiba print driver.

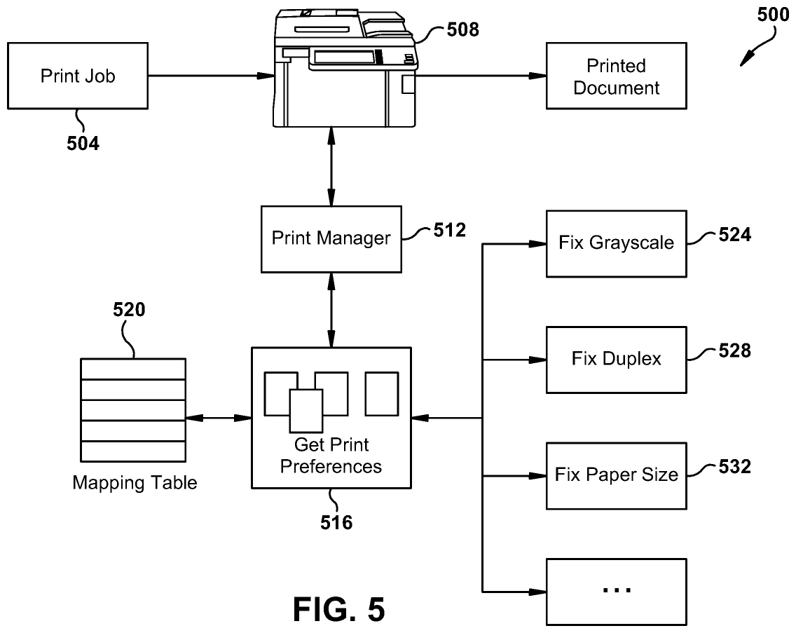

FIG. 5 illustrates an example embodiment of a software block diagram 500 of a system for dynamic translation of printer specific PJL commands. Print job 504 is sent to printer 508 including incompatible PJL codes. A print manager module 512 determines printing preferences via module 516. Detected printing preferences are mapped to compatible PJL codes via mapping table 520. As a result, issues can be resolved, such as fixing grayscale at block 524, fixing duplex at block 528, and fixing paper size at block 532.

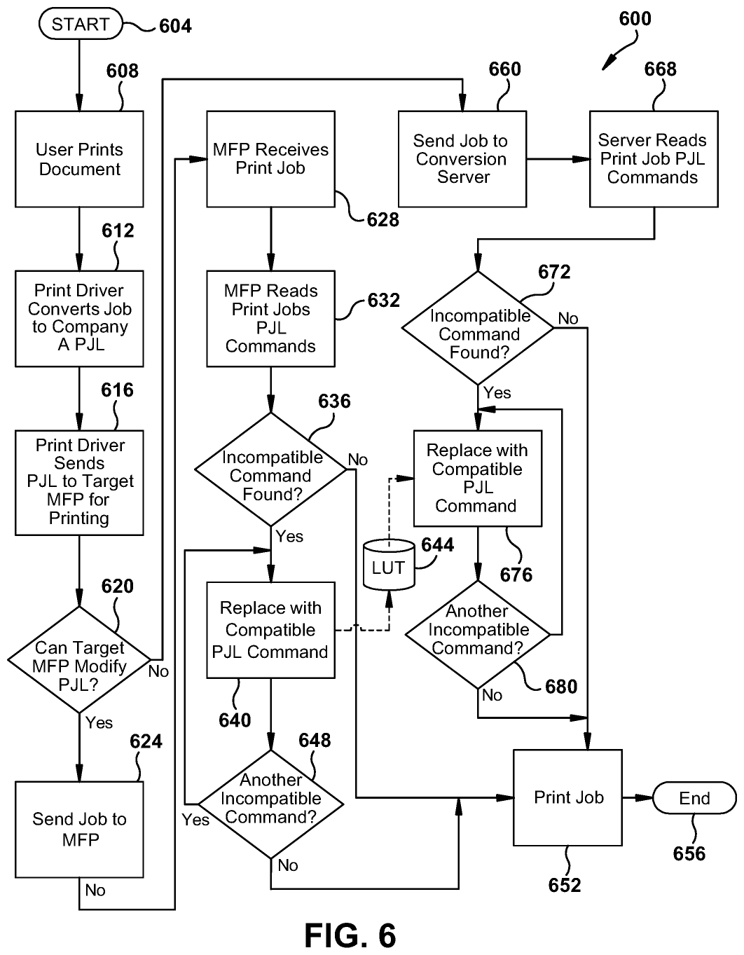

FIG. 6 illustrates flowchart 600 of an example embodiment of a system for dynamic translation of printer specific PJL commands. The system commences at block 604 and proceeds to block 608 where a user prints their document. A print driver converts the print job to Company A PJL at block 612 and sends it to a target MFP for printing at block 616. If the MFP targeted for printing includes PJL translation capabilities as determined at block 620, the job is sent to the target MFP at block 624 and it is received by the MFP at block 628. The MFP analyzes the PJL commands at block 632 and a test for incompatible codes is made at block 636.

If no incompatible codes are detected, the print job is rendered at block 652 and the process ends at block 656. Incompatible codes are replaced with compatible PJL commands at block 640 in conjunction with lookup table 644. When additional incompatible codes are determined at block 648, the process returns to block 640. Once all PJL codes are compatible, the print job is rendered at block 652 and the process ends at block 656.

If it is determined at block 620 that the MFP targeted for printing cannot modify JPL, it is sent to a conversion server 660, which may disposed with a print server. The server analyzes the PJL commands at block 668 and a test for incompatible codes is made at block 672. If no incompatible codes are detected, the print job is rendered at block 652 and the process ends at block 656. Incompatible codes are replaced with compatible PJL commands at block 676 in conjunction with lookup table 644. When additional incompatible codes are determined at block 680, the process returns to block 676. Once all PJL codes are compatible, the print job is rendered at block 652 and the process ends at block 656.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

It is claimed:

1. A system comprising:
a processor and associated memory, the memory storing a lookup table containing a mapping between PJL commands having corresponding attributes for different printers;
a network interface configured to receive a PJL encoded print job;
the processor configured to,
identify one or more PJL commands in a print job,
determine whether each identified PJL command is compatible with a print engine targeted for printing the print job, and
commence printing of the print job by the print engine when each identified PJL command is determined to be compatible with the print engine;
wherein, when an identified PJL commands is incompatible with the print engine, the processor is configured to,
replace each incompatible PJL command with a compatible PJL command having the corresponding attributes in accordance with the lookup table to form a modified PJL encoded print job, and
commence printing of the print job by the print engine with the modified PJL encoded print job.

2. The system of claim 1 wherein a received PJL encoded print job is received from a print driver associated with a first device manufacturer and wherein the print engine is associated with a second device manufacturer.

3. The system of claim 2 wherein the processor, the memory, and the network interface comprise a multifunction peripheral intelligent controller configured to control the print engine.

4. The system of claim 3 wherein custom PJL commands are directed to one or more of finishing options, paper handling, font and print mode.

5. The system of claim 4 wherein the lookup table includes the custom PJL commands corresponding to different printers from multiple manufacturers, and wherein the processor is further configured to:
determine a manufacturer associated with each identified custom PJL command; and
replace each incompatible PJL command with a compatible PJL command in accordance with a determined manufacturer.

6. The system of claim 1 wherein one or more PJL command determined to be compatible are shared by multiple manufacturers.

7. The system of claim 6 wherein the one or more PJL commands shared by multiple manufacturers is standardized by the Printer Working Group.

8. A method comprising:
identifying one or more PJL commands in a PJL encoded print job,
determining whether each identified PJL command is compatible with a print engine targeted for printing a print job,
commencing printing of the print job by the print engine when each identified PJL command is determined to be compatible with the print engine;
wherein, when one or more identified PJL commands are incompatible with the print engine,
replacing each incompatible PJL command with a compatible PJL command having corresponding attributes in accordance with a lookup table containing a mapping between PJL commands having the corresponding attributes for different printers to form a modified PJL encoded print job, and
commencing printing of the print job by the print engine with the modified PJL encoded print job.

9. The method of claim 8 further comprising receiving the PJL encoded print job from a print driver associated with a first device manufacturer and wherein the print engine is associated with a second device manufacturer.

10. The method of claim 9 wherein the method is performed by an intelligent controller of a multifunction peripheral.

11. The method of claim 10 wherein the custom PJL commands are directed to one or more of finishing options, paper handling, font and print mode.

12. The method of claim 11 wherein the lookup table includes the custom PJL commands corresponding to different printers from multiple manufacturers, further comprising:
determining a manufacturer associated with each identified custom PJL command; and
replacing each incompatible PJL command with a compatible PJL command in accordance with a determined manufacturer.

13. The method of claim 8 wherein one or more PJL command determined to be compatible are shared by multiple manufacturers.

14. The method of claim 13 wherein one or more PJL commands shared by multiple manufacturers is standardized by the Printer Working Group.

15. A non-transitory computer readable storage medium storing a program for causing a digital data device to execute a control method, the control method comprising:
identifying one or more PJL commands in a PJL encoded print job,
determining whether each identified PJL command is compatible with a print engine targeted for printing a print job,
commencing printing of the print job by the print engine when each identified PJL command is determined to be compatible with the print engine;
wherein, when one or more identified PJL commands are incompatible with the print engine,
replacing each incompatible PJL command with a compatible PJL command having corresponding attributes in accordance with a lookup table containing a mapping between PJL commands having the corresponding attributes for different printers to form a modified PJL encoded print job, and
commencing printing of the print job by the print engine with the modified PJL encoded print job.

16. The non-transitory computer readable storage medium of claim 15 wherein the control method further comprises receiving the PJL encoded print job from a print driver associated with a first device manufacturer and wherein the print engine is associated with a second device manufacturer.

17. The non-transitory computer readable storage medium of claim 16 wherein the control method is performed by an intelligent controller of a multifunction peripheral.

18. The non-transitory computer readable storage medium of claim 17 wherein the custom PJL commands are directed to one or more of finishing options, paper handling, font and print mode.

19. The non-transitory computer readable storage medium of claim 15 wherein the lookup table includes the custom PJL commands corresponding to different printers from multiple manufacturers, wherein the method further comprises:
determining a manufacturer associated with each identified custom PJL command; and
replacing each incompatible PJL command with a compatible PJL command in accordance with a determined manufacturer.

20. The non-transitory computer readable storage medium of claim 15 wherein one or more PJL command determined to be compatible are shared by multiple manufacturers.
